(19) United States
(12) Patent Application Publication
(10) Pub. No.: US 2024/0339095 A1
(43) Pub. Date: Oct. 10, 2024

(54) MUSIC DATA PROCESSING DEVICE, METHOD, AND STORAGE MEDIUM

(71) Applicant: CASIO COMPUTER CO., LTD., Tokyo (JP)

(72) Inventor: Yuji TABATA, Tokyo (JP)

(73) Assignee: CASIO COMPUTER CO., LTD., Tokyo (JP)

(21) Appl. No.: 18/626,661

(22) Filed: Apr. 4, 2024

(30) Foreign Application Priority Data
Apr. 5, 2023 (JP) 2023-061216

(51) Int. Cl. G10H 1/00

(52) U.S. Cl. CPC G10H 1/0008; G10H 2250/235

(57) ABSTRACT

A music data processing device includes at least one processor, configured to perform the following: performing calculations of Fast Fourier Transform on input data generated from music data inputted for respective processing units; and for each of bin numbers corresponding to respective calculation points of the Fast Fourier Transform, calculating and outputting a shift amount, as a phase error, that is obtained by subtracting, from a phase in a current processing unit obtained from the Fast Fourier Transform calculations, a sum of a phase in a previous processing unit obtained from the Fast Fourier Transform calculations and a normalized phase displacement, wherein the normalized phase displacement is a change in phase that is supposed to occur when the processing unit advances one unit with a bin number frequency corresponding to the bin number.

### BACKGROUND OF THE INVENTION

### Technical

The present invention relates to a process for determining a tuning value from music data and a process for determining a chord.

### Background Art

The tuning value (for example, the frequency of an A4 tone) of an acoustic signal can be determined from the music data by using an autocorrelation function if it is a single tone.

In addition to the method using an autocorrelation function, Fourier transform processing is a method often used to analyze acoustic signals. In particular, a method using FFT (Fast Fourier Transform) allows high-speed processing on a computer and is used in many signal analyses.

Yousei Matsuoka, Mizuki Watabe, “Music chord recognition technology and its applications,” NTT DOCOMO Technical Journal Vol. 25 No. 2, Jul. 2017, uses a combination of FFT and chroma vector technology to identify chords.

### SUMMARY OF THE INVENTION

One of the advantages of the present disclosure is that it is possible to obtain accurate tuning values that are necessary when playing an instrument along with a song or when determining the chord progression of a song.

Additional or separate features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and other advantages and in accordance with the purpose of the present invention, as embodied and broadly described, in one aspect, the present disclosure provides a music data processing device, comprising at least one processor, configured to perform the following: performing calculations of Fast Fourier Transform on input data generated from music data inputted for respective processing units; and for each of bin numbers corresponding to respective calculation points of the Fast Fourier Transform, calculating and outputting a shift amount, as a phase error, that is obtained by subtracting, from a phase in a current processing unit obtained from the Fast Fourier Transform calculations, a sum of a phase in a previous processing unit obtained from the Fast Fourier Transform calculations and a normalized phase displacement, wherein the normalized phase displacement is a change in phase that is supposed to occur when the processing unit advances one unit with a bin number frequency corresponding to the bin number.

In the music data processing device above, the at least one processor may be configured to perform the following: for each of bin numbers, calculating a current frequency that is a frequency obtained by multiplying the bin number frequency by a ratio of a sum of the phase error and the normalized phase displacement to the normalized phase displacement; calculating a tentative scale note based on a ratio of the current frequency to a frequency of a reference note; calculating a scale note shift amount based on a decimal part of the tentative scale note; and calculating a tuning value for the music data based on the scale note shift amount.

In another aspect, the present disclosure provides a music data processing device, comprising at least one processor, configured to perform the following: performing calculations of Fast Fourier Transform on input data generated from music data inputted for respective processing units; for each of bin numbers corresponding to respective calculation points of the Fast Fourier Transform, calculating and outputting a shift amount, as a phase error, that is obtained by subtracting, from a phase in a current processing unit obtained from the Fast Fourier Transform calculations, a sum of a phase in a previous processing unit obtained from the Fast Fourier Transform calculations and a normalized phase displacement, wherein the normalized phase displacement is a change in phase that is supposed to occur when the processing unit advances one unit with a bin number frequency corresponding to the bin number; determining a current frequency for each of the bin numbers based on the phase error; and determining a chord in the music data based on the determined current frequency for each of the bin numbers.

In the music data processing device above, said at least one processor may perform the following in determining the chord: for each of the bin numbers corresponding to the respective calculation points of the Fast Fourier Transform, calculating a true scale note for each bin number based on the tuning value for the music data and the current frequency calculated for each of the bin numbers; generating a chroma vector, which is a vector whose feature quantity is an amplitude intensity of a frequency for each tone number scale note, by distributing and synthesizing values of amplitudes that are obtained for respective bin numbers from the Fast Fourier Transform calculations into a prescribed scale note range of tone number scale notes based on an integer part and a decimal part of the true scale note calculated for each bin number and on the amplitude for each bin number; and determining the chord in the music data based on the chroma vector.

In other aspects, the present disclosure provides a method to be executed by at least one processor in a music data processing device, comprising the above-described processes, and a computer-readable non-transitory storage medium storing a program executable by at least one processor in a music data processing device, comprising the above-described processes.

It is to be understood that both the foregoing general description and the following detailed description are exemplary and explanatory, and are intended to provide further explanation of the invention as claimed.

### BRIEF DESCRIPTION OF THE DRAWINGS

FIG. 1 is a block diagram showing an example of a hardware configuration of a music data processing device.

FIG. 2 is a block diagram of a chord determination processing.

FIG. 3 is a flowchart illustrating an example of processing by a tuning value determining process.

FIG. 4A is a flowchart illustrating a processing example of the chroma vector generation process.

FIG. 4B is a flowchart illustrating a processing example of the chord determination process.

FIG. 5A is a diagram showing an example of a chord constituent note table for a major chord.

FIG. 5B is a diagram showing an example of a chord constituent note table for a minor chord.

### DETAILED DESCRIPTION OF EMBODIMENTS

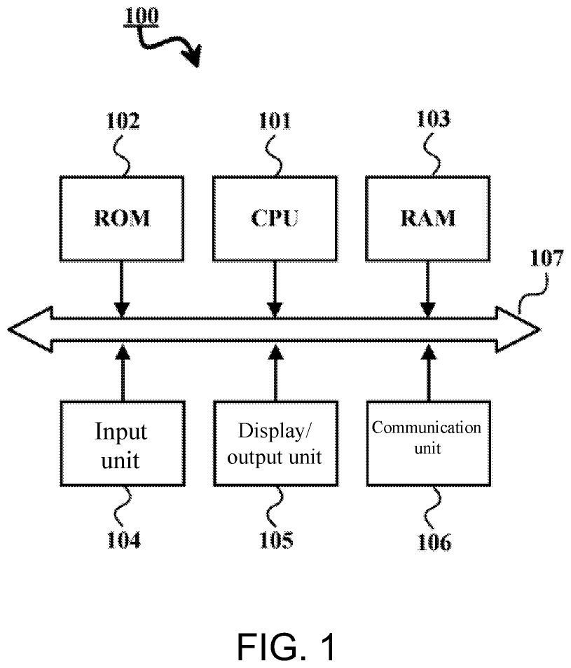

Hereinafter, embodiments for carrying out the present invention will be described in detail with reference to the drawings. FIG. 1 is a block diagram showing an example of a hardware configuration of a music data processing device 100 that can determine a tuning value of a music data and perform chord determination based on the determined tuning value.

The music data processing device 100 is a user terminal that is, for example, a smartphone terminal, a tablet terminal, or a personal computer such as a so-called laptop computer operated by a user.

The music data processing device 100 includes a CPU (Central Processing Unit) 101 as at least one processor, a ROM (Read Only Memory) 102, a RAM (Random Access Memory) 103, an input unit 104 configured by, for example, a touch panel display; a display/output unit 105, and a communication unit 106 connected to, for example, the Internet or a local area network in order to communicate with a server device or other user terminals, all of which are interconnected by a system bus 107. Other blocks that are commonly included in user terminals and are not directly related to the operation of this embodiment (for example, microphones, speakers, call functions, cameras, etc.) are omitted, but needless to say, these units may be included.

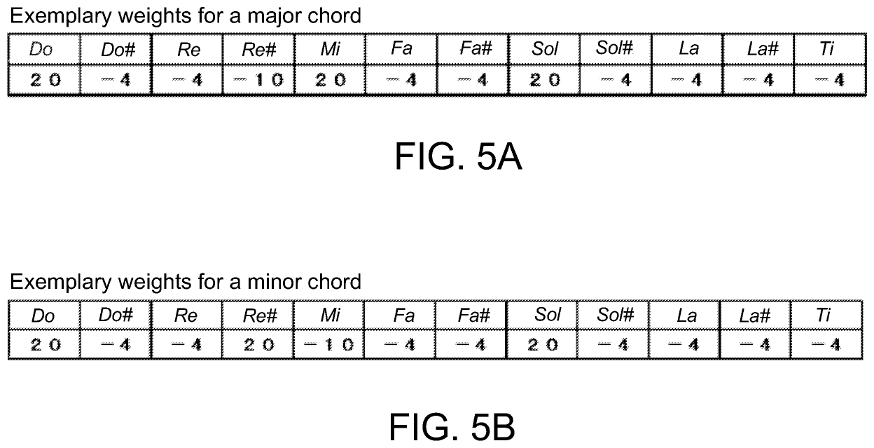

The CPU 101 executes the control operation of the music data processing device 100 of FIG. 1 by executing the control program stored in the ROM 102 while using the RAM 103 as a work memory. Further, the ROM 102 stores, in addition to the above-mentioned control program and various fixed data, for example, data of a “chord constituent note table” shown in FIGS. 5A and 5B, which will be described later. The control program and the like may not be stored in advance in the ROM 102, but may be downloaded and installed as appropriate via a network such as the Internet via the communication unit 106.

Further, although the control program is stored in the ROM 102 in this embodiment, the control program is not limited to this, and may be stored in a removable storage medium such as a USB memory, CD, DVD, etc., or may be stored in a storage medium of a server. The music data processing device 100 may acquire a control program from such a storage medium and execute it.

An example of the processing of this embodiment executed by the computer in FIG. 1 will be described in detail below. References such as “CPU 101,” “ROM 102,” or “RAM 103” are intended to refer to CPU 101, ROM 102, or RAM 103 in FIG. 1.

First, a processing unit PU, which is a processing unit that corresponds to one batch, is defined by the following equation (1).

$$PU = SR / PR ( sample / times ) \qquad ( 1 )$$

Here, SR is the sampling rate (samples/second), and PR is the FFT processing rate (times/second). Note that the FFT window size (sample) is WL.

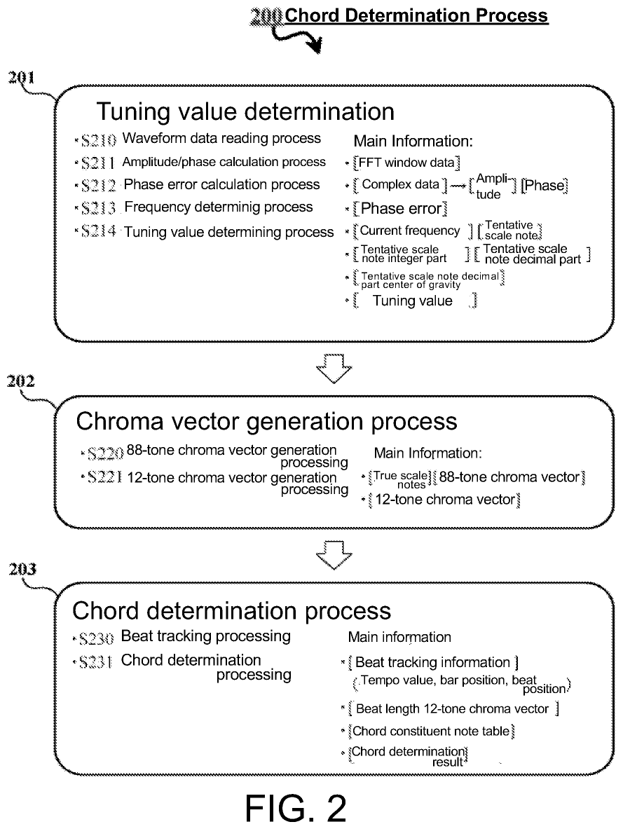

FIG. 2 is a block diagram of a chord determination processing process 200 executed by the CPU 101 and the like of the music data processing device 100 of FIG. 1. The chord determination process 200 is executed by the processing described later in the music data processing device 100, and the corresponding hardware includes at least one of the CPU 101, the ROM 102, and the RAM 103 as described above. The program executed in the chord determination process 200 is stored in the ROM 102 when the user terminal, which is the music data processing device 100 in FIG. 1 is shipped from a factory to users, and may be loaded from the ROM 102 to the RAM 103. Alternatively, the program executed in the chord determination process 200 may be such that the user provides the user terminal of the music data processing device 100 with a so-called application (app) having the functions of the chord determination process 200 by downloading and installing it via the communication unit 106 in FIG. 1 into the RAM 103 from a vendor company's website or the like via a network such as the Internet.

The chord determination process 200 is generally composed of a tuning value determination process 201, a chroma vector generation process 202, and a chord determination process 203.

The tuning value determining process 201 executes a waveform data reading process S210, an amplitude/phase calculation process S211, a phase error calculation process S212, a frequency determining process S213, and a tuning value determining process S214.

The chroma vector generation process 202 executes 88-tone chroma vector generation processing S220 and 12-tone chroma vector generation processing S221.

The chord determination process 203 executes beat tracking processing S230 and chord determination processing S231.

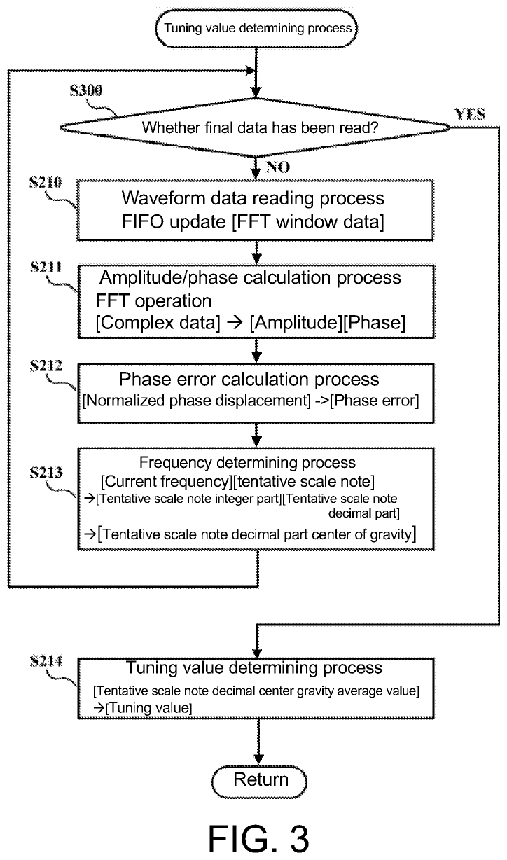

FIG. 3 is a flowchart showing a more detailed processing example of the tuning value determining process 201 of FIG. 2. The CPU 101 treats information, such as [FFT window data], [complex data] ([amplitude] [phase]), [phase error], [current frequency], and [tentative scale note], [tentative scale note integer part] and [tentative scale note decimal part], [tentative scale note decimal part center of gravity], and [tuning value], which are described as [main information], in the block of the tuning value determining process 201 of FIG. 2, as variables stored in the RAM 103

In FIG. 3, the CPU 101 reads the waveform data of music data to be subjected to chord determination, which is read from an external network (such as the Internet) via the ROM 102 or the communication unit 106, into the RAM 103 sequentially with the processing unit PU that was defined by the above-mentioned equation (1): [Samples/times]=SR (sampling rate [samples/seconds])/PR (FFT processing rate [times/seconds]). Here, first, it is determined whether the final data of the waveform data has been read (step S300 in FIG. 3).

If the final data has not been read and the determination in step S300 is NO, the CPU 101 executes the waveform data reading process S210 described in FIG. 2. Specifically, the CPU 101 loads new waveform data of the PU sample into the RAM 103, and also sets FFT window data having an FFT window size WL [samples] from the ROM 102 into a FIFO (First In, First Out) buffer, which is a register or the like, in the RAM 103 or a memory built in the CPU 101.

Next, the CPU 101 executes the amplitude/phase calculation process S211 described in FIG. 2.

Specifically, the CPU 101 first multiplies a sample of the music data on the RAM 103 with a sample of the FFT window data in the FIFO buffer for each corresponding sample so that the center sample of the latest processing unit PU (sample) of music data that has been read into the RAM 103 for each processing unit PU [sample] and the center sample of the FFT window data set in the FIFO buffer are matched.

Next, the CPU 101 performs an FFT operation on the multiplication result data for the FFT window size WL [samples].

Furthermore, the CPU 101 obtains complex data that is the result of the FFT calculation for each FFT bin number “bin” (hereinafter referred to as the bin number “bin”) obtained as a result of the FFT calculation, and calculates the amplitude and phase from the complex data. Here, the calculation point of the FFT calculation is equal to the FFT window size WL [sample], but the calculation results from 0 to (WL/2)-1 and the calculation results from WL/2 to WL-1 have a mirror image relationship. Therefore, the bin number “bin” corresponds to the FFT calculation point and takes a value of 0≤bin<(FFT window size WL)/2, which is half the number of calculation points.

Now, if the real part of the complex data at the bin number “bin” is re (bin) and the imaginary part is im (bin), the amplitude Amp (bin) and the phase Phs (bin) at the bin number “bin” are calculated by the following formulae (2) and (3).

$$Amp ( bin ) = Sqrt ( re ( bin ) \times re ( bin ) + im ( bin ) \times im ( bin ) ) \qquad ( 2 )$$

Here, “Sqrt(n)” is a calculation function that calculates the square root of n.

$$Phs ( bin ) = A tan ( im ( bin ) , re ( bin ) ) \qquad ( 3 )$$

Here, “Atan (y, x)” is a calculation function that calculates the arctangent of y with respect to x.

Returning to the explanation of FIG. 3, after the above amplitude/phase calculation process S211, the CPU 101 executes the phase error calculation process S212 described in FIG. 2.

Specifically, the CPU 101 first calculates, for each bin number bin (0≤bin<(FFT window size WL)/2) corresponding to the FFT calculation point, the FFT bin frequency BFQ(bin) (bin number frequency) according to the calculation shown in the formula (4) below.

$$BFQ ( bin ) = SR \times bin / WL \qquad ( 4 )$$

As shown in equation (4) above, the FFT bin frequency BFQ (bin) (Hz=1/sec) is calculated by multiplying the ratio of the bin number “bin” to the FFT window size WL (samples) by the sample rate SR (samples/second) of the music data. That is, the FFT bin frequency BFQ (bin) is a frequency determined depending on the FFT calculation point indicated by the bin number “bin”.

Next, for each bin number “bin”, the CPU 101 calculates a normalized phase displacement NPD(bin), which is the phase amount to be displaced when the processing unit PU is advanced in one unit (=SR/PR[sample]) with the FFT bin frequency BFQ(bin) calculated in the formula (4) above according to the calculation shown by the following equation (5).

$$NPD ( bin ) = 2 π \times BFQ ( bin ) \times PU / SR \qquad ( 5 )$$

Here, π is the circumference ratio, pi.

Next, for each bin number “bin”, the CPU 101 performs the calculation shown in the following equation (6) to derive a phase error ePhs (bin), which is a shift amount that is obtained by subtracting, from the Phs1 (bin) in the current processing unit calculated from the complex data that is the FFT calculation result by the calculation shown in equation (3), the result of adding the normalized phase displacement NPD (bin) calculated by the calculation shown in equation (5) to the phase Phs0 (bin) in the previous processing unit calculated the same way.

$$ePhs ( bin ) = Phs 1 ( bin ) - ( Phs 0 ( bin ) + NPD ( bin ) ) \% ( 2 π ) \qquad ( 6 )$$

Note that the phase error ePhs (bin) does not exceed the range of ±1 by adjusting the sampling rate SR [number of samples/second], FFT processing rate PR [times/second], and FFT window size WL [sample] defined by equation (1). Here, “%” is a remainder calculation expression, and the right side of equation (6) means the remainder obtained by dividing (Phs0 (bin)+NPD (bin)) by 2π is subtracted from Phs1 (bin).

The sum of the phase Phs0 (bin) in the previous processing unit and the normalized phase displacement NPD (bin) calculated by the calculation shown in equation (5) should match the phase Phs1 (bin) in the current processing unit. However, in reality, in the case where the frequency of the music data is different from the FFT bin frequency BFQ (bin) calculated by the calculation shown in equation (4), the above two do not match, so the above difference between Phs1 (bin) and (Phs0 (bin)+NPD (bin)) %(2π) is calculated using formulae (4), (5) and (6), as the phase error ePhs (bin), in terms of the reminder after dividing by 2π.

Returning to the explanation of FIG. 3, after the above phase error calculation process S212, the CPU 101 executes the frequency determining process S213 described in FIG. 2.

Specifically, the CPU 101 first calculates the current frequency cFq (bin) and tentative scale note vNt (bin) from the phase error ePhs (bin) calculated in the phase error calculation processing S212 for each bin number “bin” (0≤bin<(FFT window size WL)/2).

The result of adding the phase error ePhs (bin) calculated by the calculation shown by equation (6) to the normalized phase displacement NPD (bin) calculated by the calculation shown by equation (5) is divided by the normalized phase displacement NPD (bin) to calculate the ratio of the actual phase to the normalized phase displacement NPD (bin).

Then, the CPU 101 calculates the current frequency cFq (bin) for each bin number “bin” by multiplying the FFT bin frequency BFQ (bin) calculated by the calculation of equation (4) by said ratio in accordance with the equation (7).

$$cFq ( bin ) = BFQ ( bin ) \times ( NPD ( bin ) + ePhs ( bin ) / NPD ( bin ) \qquad ( 7 )$$

Further, the CPU 101 uses the current frequency cFq (bin) calculated by the calculation shown by the equation (7) for each bin number bin to calculate the tentative scale note vNt (bin) by the calculation shown by the following equation (8). calculate.

$$vNt ( bin ) = Log ( cFq ( bin ) / 440. , 2. ) \times 12 + 69 \qquad ( 8 )$$

Here, “69” is the scale note number of A4 note. Further, Log (x, 2.0) is an arithmetic function that calculates the base 2 logarithm of x.

As shown in the above equation (8), the tentative scale note vNt (bin) at the bin number “bin” is calculated by calculating the base-2 logarithm of the result of dividing the current frequency cFq (bin) at the bin number “bin” by the frequency of 440 Hz of the A4 reference tone which is the primary tone frequency of a prescribed pitch, and by multiplying the result by 12, and adding the scale note number of A4 note=69.

Subsequently, when the total value of the amplitude Amp (bin) of the complex data, which is calculated by the equation (2), for all of the bin numbers “bin” (0≤bin<(FFT window size WL)/2), is greater than a prescribed value, the CPU 101 calculates the tentative scale note integer part ivNt (bin)) as shown in the following equation (9), by rounding off the decimal part of the tentative scale note vNt (bin) calculated by equation (8) for each bin number “bin”.

$$ivNt ( bin ) = the result of rounding the decimal part of vNt ( bin ) \qquad ( 9 )$$

Furthermore, as shown in the following equation (10), the CPU 101 calculates, for each bin number “bin”, the tentative scale note decimal part fvNt (bin) by subtracting the calculated tentative scale note integer part ivNt (bin) calculated by equation (9) from the tentative scale note vNt (bin) calculated by equation (8).

$$fvNt ( bin ) = vNt ( bin ) - ivNt ( bin ) \qquad ( 10 )$$

Since the calculation shown in equation (9) is a rounding calculation, the tentative scale note decimal part fvNt (bin) calculated by the calculation shown in equation (10) fits in the range of −0.5 or more and less than 0.5. The tentative scale note decimal part fvNt (bin) calculated by the calculation shown in equation (10) can be considered as the scale note shift amount for each bin number “bin”.

The CPU 101 further calculates the tentative scale note decimal part gravity center Flt, which is the center of gravity of the tentative scale note decimal part fvNt (bin) with the amplitude Amp (bin) (see formula (2)) over the range of the bin numbers “bin's” in which the tentative scale note integer part ivNt (bin) calculated by the calculation shown in equation (9) is within a predetermined note range (for example, 36 (C2) to 95 (B6)), using the following formula (11).

$$Flt = \frac{{\sum }_{bin = {min}_{bin}}^{{max}_{bin}} Amp ( bin ) \cdot fvNt ( bin )}{{\sum }_{bin = {min}_{bin}}^{{max}_{bin}} Amp ( bin )} \qquad ( 11 )$$

Here, bin is the bin number, miniₙ is the minimum bin number of the predetermined range, max_{bin} is the maximum bin number of the predetermined note range, and Amp (bin) is the amplitude at the bin number “bin” calculated by the calculation of equation (2), and fvNt (bin) is the tentative scale note decimal part of the bin number “bin” calculated by the calculation of equation (10). Note that in order to satisfy the above equation, the amplitudes must be equal to or greater than a predetermined threshold.

In other words, the CPU 101 calculates the tentative scale note decimal part fvNt (bin) by the calculation shown in equation (10) for each bin number “bin” within the predetermined range within one processing unit PU, and by calculating, for example, the center of gravity of the tentative scale note decimal part fvNt (bin), the tentative scale note decimal part center of gravity Flt, which is the scale note shift amount for each processing unit corresponding to one processing unit, is calculated.

Returning to the explanation of FIG. 3, after the above frequency determining process S213, the CPU 101 returns to the determination process of step S300. In this way, the CPU 101 repeatedly performs the waveform data reading process S210, the amplitude/phase calculation process S211, the phase error calculation process S212, and the frequency determining process S213 for the respective processing units PU's [sample] until it is determined that the processes from the waveform data reading process S210 to the frequency determining process S213 are completed with the last data. Through this iterative process, the CPU 101 can calculate the tentative scale note decimal part center of gravity Flt, which is the scale note shift amount for the corresponding processing unit, for each of the processing units PU's [sample] from the beginning to the end of the music data.

When the music data for chord determination is read to the final data for each processing unit PU [sample] and the processing from the waveform data reading processing S210 to the frequency determining process S213 is completed and the determination in step S300 in FIG. 3 becomes YES, the CPU 101 executes the tuning value determining process S214 explained in FIG. 2.

Specifically, the CPU 101 first calculates the tentative scale note decimal part center gravity average value aFlt, which is the average value of the tentative scale note decimal part gravity centers Flt obtained for the respective processing units PU's [sample] from the beginning to the end of the music data.

It can be said that this tentative scale note decimal part gravity center average value aFlt corresponds to the scale note shift amount of the entire music data.

Then, the CPU 101 determines the tuning value sTun by using the above-described calculated tentative scale note decimal part center of gravity average value aFlt by the calculation shown in the formula (12) below.

$$sTun = 440. \times Pow ( 2. , aFlt / 12 ) \qquad ( 12 )$$

Here, Pow(x, y) is a calculation function that calculates x to the power of y.

In the calculation shown by the above formula (12), the CPU 101 calculates 2 to the power of [the result of dividing the tentative scale note decimal part center of gravity average value aFlt corresponding to the scale note shift amount of the entire music data by 12]. This way, the scale note shift rate per note is calculated, and the scale note shift rate is multiplied by the primary tone frequency of a prescribed scale note, for example, the frequency 440.0 (Hz) of the A4 reference tone so as to calculate the tuning value sTun for the music data.

As described above, the tuning value sTun for the entire music data can be calculated by the tuning value determining process 201 of FIG. 2 shown in the flowchart of FIG. 3.

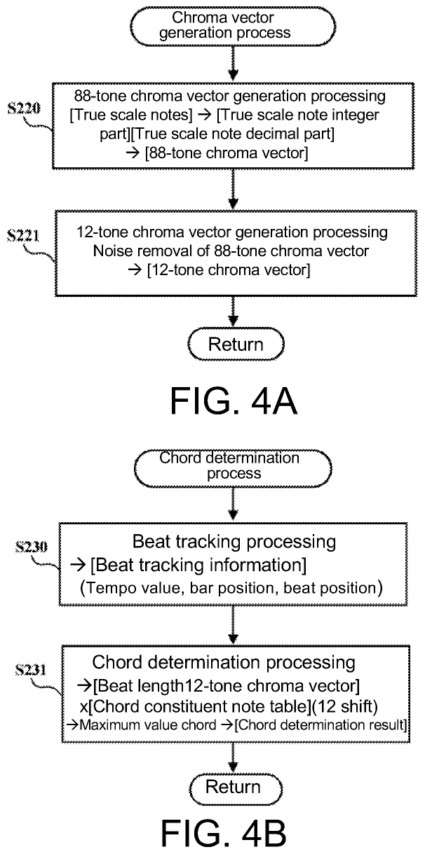

FIG. 4A is a flowchart showing a more detailed processing example of the chroma vector generation process 202 in FIG. 2. The CPU 101 treats information, such as [true scale notes], [88-tone chroma vector], and [12-tone chroma vector], which are described as “main information” in the block of the chroma vector generation process 202 in FIG. 2, as variables stored in the RAM 103.

First, the CPU 101 executes the 88-tone chroma vector generation processing S220 described in FIG. 2.

Specifically, the CPU 101 calculates, by the calculation shown in the formula (13), the true scale note sNt (bin) for each bin number “bin” based on the tuning value sTun over the entire music data calculated by the calculation shown by equation (12) in the tuning value determining process 201 of FIGS. 2 and 3 and on the current frequency cFq (bin) for each bin number bin (0≤bin<(FFT window size WL)/2) calculated by the calculation shown by equation (7) in the frequency determining process S213 in FIG. 2.

$$sNt ( bin ) = Log ( cFq ( bin ) / sTun , 2. ) \times 12 + 69 \qquad ( 13 )$$

Here, “69” is the scale note number of the A4 note, similar to when the tentative scale note vNt (bin) was calculated by the calculation shown in equation (8). As shown in the above equation (13), the true scale note sNt (bin) at the bin number “bin” is calculated by calculating the base-2 logarithm of the division result of dividing the current frequency cFq (bin) at the bin number “bin” by the tuning value sTun calculated by the calculation shown in the equation (12), multiplying the result by 12, and by adding the result to A4 scale note number=69.

Next, as shown in equation (14) below, the CPU 101 calculates the true scale note integer part iNt (bin) by cutting off the decimal part of the true scale note sNt (bin) calculated by the calculation shown in equation (13) for each bin number “bin”.

$$iNt ( bin ) = Result of cutting off the decimal part of sNt ( bin ) \qquad ( 14 )$$

Furthermore, as shown in the following equation (15), the CPU 101 calculates, for each bin number “bin”, the true scale note decimal part fNt (bin) by subtracting the calculated true scale note integer part iNt (bin) obtained by the calculation shown in equation (14) from the true scale note sNt (bin) calculated by the calculation shown in equation (13).

$$fNt ( bin ) = sNt ( bin ) - iNt ( bin ) \qquad ( 15 )$$

Since the equation (14) cut off the decimal part, the true scale note decimal part fNt (bin) calculated by the calculation shown in the equation (15) falls within the range of 0.0 or more and less than 1.0.

Next, the CPU 101 converts the amplitude Amp (bin) calculated by the calculation shown by equation (2) for each bin number “bin” into tone number scale notes distributed and synthesized in a predetermined scale note range based on the true scale note integer part iNt (bin) calculated for each bin number “bin” by the calculation shown by equation (14) and on the true scale note decimal part fNt (bin) calculated for each bin number “bin” by the calculation shown in equation (15), so as to generate, a chroma vector CRV [n], which is a vector whose feature quantity is the amplitude intensity of the frequency for each tone number scale note.

More specifically, if the 88-tone chroma vector is expressed as CRV88 [n] (n: 0-87) in the entire musical range of the music data, for example, in the 88-tone scale from A0 (21) to C8 (108), the CPU 101 generates an 88-tone chroma vector CRV88 [n] by the respective distribution (synthesis) operations shown in the following equations (16) and (17).

$$CRV 88 [ iNt ( bin ) - 21 ] += Amp ( bin ) \times ( 1. - fNt ( bin ) ) \qquad ( 16 )$$

$$CRV 88 [ iNt ( bin ) + 1 - 21 ] += Amp ( bin ) \times fNt ( bin ) \qquad ( 17 )$$

Here, “+=” is a compound assignment operator, which means adding the value on the left side and the value on the right side of the expression and putting the result into the variable on the left side.

Returning to the explanation of FIG. 4A, the CPU 101 executes the 12-tone chroma vector generation processing S221 described in FIG. 2 after the 88-tone chroma vector generation processing S220.

Specifically, the CPU101 performs a resynthesis operation to round to a 12-tone scale after noise is removed based on the minimum value of the three adjacent scale notes (n−1, n, n+1) of the 88-tone chroma vector CRV88 [n] (n: 0 to 87) calculated by the respective calculations shown in equations (16) and (17).

Here, if the 12-tone chroma vector is expressed as CRV12 [m] (m: 0 to 11), it is calculated by the resynthesis operation shown by the following equation (18).

$$CRV 12 [ ( n + 21 ) \%12 ] += CRV 88 [ n ] \qquad ( 18 )$$

Here, n: 0 to 87, and %12 is a remainder operation divided by 12.

As described above, the chroma vector generation process 202 of FIG. 2 shown in the flowchart of FIG. 4A is performed to generate the 88-tone chroma vector CRV88 [n] (n: 0 to 87) and the 12-tone chroma vector CRV12 [m] (m: 0 to 11).

FIG. 4B is a flowchart showing a detailed processing example of the chord determination process 203 in FIG. 2. The CPU 101 treats information, such as [beat tracking information] (tempo value, bar position, beat position), [beat length 12-tone chroma vector], [chord constituent note table], and [chord determination result], which are described as [main information] in the block of the chord determination process 203 of FIG. 2, as variables stored in the RAM 103.

First, the CPU 101 executes the beat tracking process S230 described in FIG. 2.

Specifically, the CPU 101 detects [Beat tracking information] (tempo value, bar position, beat position) based on the changes in volume of music data and in the constituent sounds, for example, based on the change in the 12-tone chroma vector CRV12 [m] calculated by equation (18) in the 12-tone chroma vector generation process S221 in FIG. 4A in the chroma vector generation process 202 in FIG. 2.

Next, the CPU 101 executes the chord determination processing S231 described in FIG. 2.

Specifically, the CPU 101 determines the length of time for chord determination based on [beat tracking information] calculated in the beat tracking process S230 of FIG. 4B, and creates [beat length 12-tone chroma vector] whose element value is the sum of the element values of the 12-tone chroma vector CRV12 [m] obtained by the calculation shown in equation (18) for the corresponding time length.

Furthermore, the CPU 101 multiplies the above-mentioned [beat length 12-note chroma vector] by the values of [chord constituent note table] weighted by the constituent notes/non-constituent notes of a possible chord to find a chord at which the largest/maximum value is achieved and stores such a chord to [chord determination result] by the calculation shown in the following equation (19).

$$Total maximum value of [ Beat length 12 - tone chroma vector ] \times [ \text{} Chord constituent note table ] \to [ Chord determination result ] \qquad ( 19 )$$

Note that the CPU 101 shifts the [chord constituent note table] 12 times to take into account the difference in root notes.

FIGS. 5A and 5B are diagram illustrating table examples of the weighting structure of the [chord constituent note table] with the C (do) note as the reference (root note). The table of FIG. 5A shows a case of a major chord, and the table of FIG. 5B shows a case of a minor chord.

In FIGS. 5A and 5B, the weight of the constituent notes takes a positive value, and is set to 20 for each triad (60 in total). Non-constituent notes take negative values, and in particular major/minor thirds, which are the difference between major/minor chords, have large absolute values.

In this disclosure, the term “at least” means, unless otherwise specified, that, for example, “at least one of A, B, and C” means “(A), (B), (C), (A and B), (A and C), (B and C), or (A, B and C), including combinations of the plurality or numbers greater than or equal to the indicated number. For example, if C is plural, the term “at least one of A, B, and C” means “(A), (B), (at least one or more of C), (A and B), (A and at least one or more C), (B and at least one or more C), or (A, B, and at least one or more C). If there is more than one A or more than one B, it will be interpreted in the same way as above.

Conventionally, frequency information in analysis results obtained by FFT is a composite of discrete values for respective FFT bin numbers, and is not suitable for detecting frequencies that take continuous values such as tuning values of the entire music. In response to this issue, according to embodiments of the present invention, it is now possible to obtain accurate tuning values needed when playing an instrument to match the music or determining the chord progression of the music, making it easier to perform tuning operations. Further, based on this tuning value, it becomes possible to obtain more accurate chord determination results. Note that the embodiments described above are presented as examples, and are not intended to limit the scope of the invention. The embodiment can be implemented in various other forms, and various omissions, substitutions, and changes can be made without departing from the spirit of the invention. This embodiment and its modifications are included within the scope and gist of the invention, as well as within the scope of the invention described in the claims and its equivalents. Therefore, it will be apparent to those skilled in the art that various modifications and variations can be made in the present invention without departing from the spirit or scope of the invention. Thus, it is intended that the present invention cover modifications and variations that come within the scope of the appended claims and their equivalents. In particular, it is explicitly contemplated that any part or whole of any two or more of the embodiments and their modifications described above can be combined and regarded within the scope of the present invention.

What is claimed is:

1. A music data processing device, comprising at least one processor, configured to perform the following:
performing calculations of Fast Fourier Transform on input data generated from music data inputted for respective processing units; and
for each of bin numbers corresponding to respective calculation points of the Fast Fourier Transform, calculating and outputting a shift amount, as a phase error, that is obtained by subtracting, from a phase in a current processing unit obtained from the Fast Fourier Transform calculations, a sum of a phase in a previous processing unit obtained from the Fast Fourier Transform calculations and a normalized phase displacement, wherein the normalized phase displacement is a change in phase that is supposed to occur when the processing unit advances one unit with a bin number frequency corresponding to the bin number.

2. The music data processing device according to claim 1, wherein the at least one processor is configured to perform the following:
for each of bin numbers, calculating a current frequency that is a frequency obtained by multiplying the bin number frequency by a ratio of a sum of the phase error and the normalized phase displacement to the normalized phase displacement;
calculating a tentative scale note based on a ratio of the current frequency to a frequency of a reference note;
calculating a scale note shift amount based on a decimal part of the tentative scale note; and
calculating a tuning value for the music data based on the scale note shift amount.

3. The music data processing device according to claim 1, wherein the at least one processor calculates the bin number frequency corresponding to the bin number by multiplying a sampling rate of the music data by a ratio of the bin number to a window size of window data that is multiplied onto the music data for each sampling prior to the Fast Fourier Transform.

4. The music data processing device according to claim 2, wherein the at least one processor executes the following:
(a) calculating the decimal part of the tentative scale note as a scale note shift amount for each bin number;
(b) calculating a scale note shift amount for each processing unit by performing the process (a) for all of the bin numbers within a prescribed note range within the processing unit; and
(c) calculating a scale note shift amount for an entirety of the music data by performing the process (b) for all of the processing units that span over the entirety of the music data.

5. The music data processing device according to claim 2, wherein the at least one processor calculates the tuning value for the music data by calculating a scale note shift rate per note from the scale note shift amount and multiplying the scale note shift rate by a primary tone frequency of a prescribed scale note.

6. The music data processing device according to claim 1, further comprising:
determining a current frequency for each of the bin numbers based on the phase error; and
determining a chord in the music data based on the determined current frequency for each of the bin numbers.

7. The music data processing device according to claim 6, wherein said at least one processor performs the following in determining the chord:
for each of the bin numbers corresponding to the respective calculation points of the Fast Fourier Transform, calculating a true scale note for each bin number based on the tuning value for the music data and the current frequency calculated for each of the bin numbers;
generating a chroma vector, which is a vector whose feature quantity is an amplitude intensity of a frequency for each tone number scale note, by distributing and synthesizing values of amplitudes that are obtained for respective bin numbers from the Fast Fourier Transform calculations into a prescribed scale note range of tone number scale notes based on an integer part and a decimal part of the true scale note calculated for each bin number and on the amplitude for each bin number; and
determining the chord in the music data based on the chroma vector.

8. The music data processing device according to claim 7, wherein the at least one processor performs the following:
generating, as said chroma vector, an n-note chroma vector corresponding to an n-note scale of an entire musical range having a number of notes n (n>12), and a 12-tone chroma vector that is converted from the n-note chroma vector by rounding to a 12-tone scale;
detecting a tempo value, a bar position and a beat position, as beat tracking information, based on changes in the 12-tone chroma vector;
determining a time length for chord determination based on the beat tracking information;
generating a beat length 12-tone chroma vector whose element value is a sum of the element values of the 12-tone chroma vector for the time length; and
outputting, as a chord determination result, a chord that attains the largest value in a multiplication result of the beat length 12-tone chroma vector with values of chord constituent note tables having weights in accordance with constituent notes and non-constituent notes of the chord.

9. The music data processing device according to claim 6, wherein the at least one processor calculates the bin number frequency corresponding to the bin number by multiplying a sampling rate of the music data by a ratio of the bin number to a window size of window data that is multiplied onto the music data for each sampling prior to the Fast Fourier Transform.

10. A method to be executed by at least one processor in a music data processing device, comprising:
performing calculations of Fast Fourier Transform on input data generated from music data inputted for respective processing units; and
for each of bin numbers corresponding to respective calculation points of the Fast Fourier Transform, calculating and outputting a shift amount, as a phase error, that is obtained by subtracting, from a phase in a current processing unit obtained from the Fast Fourier Transform calculations, a sum of a phase in a previous processing unit obtained from the Fast Fourier Transform calculations and a normalized phase displacement, wherein the normalized phase displacement is a change in phase that is supposed to occur when the processing unit advances one unit with a bin number frequency corresponding to the bin number.

11. The method according to claim 10, wherein the method includes the following:
for each of bin numbers, calculating a current frequency that is a frequency obtained by multiplying the bin number frequency by a ratio of a sum of the phase error and the normalized phase displacement to the normalized phase displacement;
calculating a tentative scale note based on a ratio of the current frequency to a frequency of a reference note;
calculating a scale note shift amount based on a decimal part of the tentative scale note; and
calculating a tuning value for the music data based on the scale note shift amount.

12. The method according to claim 10, further comprising:
determining a current frequency for each of the bin numbers based on the phase error; and
determining a chord in the music data based on the determined current frequency for each of the bin numbers.

13. The method according to claim 12, wherein the method includes the following in determining the chord:
for each of the bin numbers corresponding to the respective calculation points of the Fast Fourier Transform, calculating a true scale note for each bin number based on the tuning value for the music data and the current frequency calculated for each of the bin numbers;
generating a chroma vector, which is a vector whose feature quantity is an amplitude intensity of a frequency for each tone number scale note, by distributing and synthesizing values of amplitudes that are obtained for respective bin numbers from the Fast Fourier Transform calculations into a prescribed scale note range of tone number scale notes based on an integer part and a decimal part of the true scale note calculated for each bin number and on the amplitude for each bin number; and
determining the chord in the music data based on the chroma vector.

14. A computer-readable non-transitory storage medium storing a program executable by at least one processor in a music data processing device, the program causing the at least one processor to perform the following:
performing calculations of Fast Fourier Transform on input data generated from music data inputted for respective processing units; and
for each of bin numbers corresponding to respective calculation points of the Fast Fourier Transform, calculating and outputting a shift amount, as a phase error, that is obtained by subtracting, from a phase in a current processing unit obtained from the Fast Fourier Transform calculations, a sum of a phase in a previous processing unit obtained from the Fast Fourier Transform calculations and a normalized phase displacement, wherein the normalized phase displacement is a change in phase that is supposed to occur when the processing unit advances one unit with a bin number frequency corresponding to the bin number.

15. The computer-readable non-transitory storage medium according to claim 14, wherein the program causes the at least one processor to perform the following:
for each of bin numbers, calculating a current frequency that is a frequency obtained by multiplying the bin number frequency by a ratio of a sum of the phase error and the normalized phase displacement to the normalized phase displacement;
calculating a tentative scale note based on a ratio of the current frequency to a frequency of a reference note;
calculating a scale note shift amount based on a decimal part of the tentative scale note; and
calculating a tuning value for the music data based on the scale note shift amount.

16. The computer-readable non-transitory storage medium according to claim 14, wherein the program causes the at least one processor to further perform the following:
determining a current frequency for each of the bin numbers based on the phase error; and
determining a chord in the music data based on the determined current frequency for each of the bin numbers.

17. The computer-readable non-transitory storage medium according to claim 16, wherein the program causes the at least one processor to perform the following in determining the chord:
for each of the bin numbers corresponding to the respective calculation points of the Fast Fourier Transform, calculating a true scale note for each bin number based on the tuning value for the music data and the current frequency calculated for each of the bin numbers;
generating a chroma vector, which is a vector whose feature quantity is an amplitude intensity of a frequency for each tone number scale note, by distributing and synthesizing values of amplitudes that are obtained for respective bin numbers from the Fast Fourier Transform calculations into a prescribed scale note range of tone number scale notes based on an integer part and a decimal part of the true scale note calculated for each bin number and on the amplitude for each bin number; and
determining the chord in the music data based on the chroma vector.
